(19) United States
(12) Patent Application Publication
(10) Pub. No.: US 2019/0126831 A1
(43) Pub. Date: May 2, 2019

(54) IRMS AR OBJECT DETECTION AND CLASSIFICATION

(71) Applicant: Panasonic Automotive Systems Company of America, Division of Panasonic Corporation of North America, Peachtree City, GA (US)

(72) Inventors: DEREK B. ARCINIAGA, ANN ARBOR, MI (US); JEFF JUDD, ROCHESTER, MI (US); PADHU KANAGARAJ, FARMINGTON HILLS, MI (US)

(73) Assignee: Panasonic Automotive Systems Company of America, Division of Panasonic Corporation of North America

(21) Appl. No.: 16/171,537

(22) Filed: Oct. 26, 2018

Related U.S. Application Data
(60) Provisional application No. 62/579,684, filed on Oct. 31, 2017.

(51) Int. Cl. B60R 1/12; B60R 1/08

(52) U.S. Cl. CPC B60R 1/12; B60R 1/08; B60R 2001/1223; B60R 2001/1253; B60R 2001/1215

(57) ABSTRACT

A rearview display arrangement for a motor vehicle includes a rearview image sensor positioned to capture first images of a scene behind the motor vehicle. A rearview display screen has a display mode and a mirror mode. The rearview display screen in the display mode receives video signals based on the captured first images and displays second images based on the video signals. In the mirror mode, the rearview display screen functions as a rearview mirror. An information source provides real time information about an object in the first images and in the second images. An electronic processing apparatus is communicatively coupled to the rearview image sensor, to the rearview display screen, and to the information source. The electronic processing apparatus enhances the second images to emphasize the object in the second images. The enhancing of the second images is dependent upon the real-time information about the object.

### CROSS-REFERENCE TO RELATED APPLICATION

This application claims benefit of U.S. Provisional Application No. 62/579,684 filed on Oct. 31, 2017, which the disclosure of which is hereby incorporated by reference in its entirety for all purposes.

### FIELD OF THE INVENTION

The disclosure relates to an intelligent rearview mirror system (IRMS) in a motor vehicle.

### BACKGROUND OF THE INVENTION

Current systems in the market may indicate a threat approaching from the rear of the vehicle but they do not convey to the driver what the object is, or highlight the object's path in relation to the vehicle.

The current implementation of augmented reality information is displayed in the head up display (HUD) for the vehicle moving forward.

### SUMMARY

The present invention may use vehicle systems such as radar, sonar and V2X/DSRC, and camera/vision systems to detect and classify objects (e.g., bicyclists, pedestrians, other vehicles, motorcyclists, etc.) in the driver's field of view (in the rearview mirror) behind the vehicle. The invention may display notifications, overlays, and colors (e.g., red or green dotted lines to the object) to communicate to the driver relevant and/or necessary information via augmented reality in the intelligent rearview mirror display system (IRMS).

In one embodiment, the invention comprises a rearview display arrangement for a motor vehicle including a rearview image sensor positioned to capture first images of a scene behind the motor vehicle. A rearview display screen has a display mode and a mirror mode. The rearview display screen in the display mode receives video signals based on the captured first images and displays second images based on the video signals. In the mirror mode, the rearview display screen functions as a rearview mirror. An information source provides real-time information about an object in the first images and in the second images. An electronic processing apparatus is communicatively coupled to the rearview image sensor, to the rearview display screen, and to the information source. The electronic processing apparatus enhances the second images to emphasize the object in the second images. The enhancing of the second images is dependent upon the real-time information about the object.

In another embodiment, the invention comprises a rearview display method for a motor vehicle, including capturing first images of a scene behind the motor vehicle. A rearview display screen is provided having a display mode and a mirror mode. The rearview display screen in the display mode receives video signals based on the captured first images and displays second images based on the video signals. The rearview display screen in the mirror mode functions as a rearview mirror. Real-time information is provided about an object in the first images and in the second images. The second images are enhanced to emphasize the object in the second images. The enhancing of the second images is dependent upon the real-time information about the object.

In yet another embodiment, the invention comprises a rearview display arrangement for a motor vehicle. The arrangement includes a rearview camera positioned to capture first images of a scene behind the motor vehicle. A rearview display screen has a display mode and a mirror mode. The rearview display screen in the display mode receives video signals based on the captured first images and displays second images based on the video signals. The rearview display screen in the mirror mode functions as a rearview mirror. A sensor provides real-time location information about an object. The object is in the first images and in the second images. An electronic processing apparatus is communicatively coupled to the rearview camera, to the rearview display screen, and to the sensor. The electronic processing apparatus identifies the object based upon the real-time location information about the object and the captured first images. The electronic processing apparatus informs a driver of the motor vehicle about an identity of the object, and enhances the second images to thereby bring the driver's attention to the object in the second images.

### BRIEF DESCRIPTION OF THE DRAWINGS

A better understanding of the present invention will be had upon reference to the following description in conjunction with the accompanying drawings.

FIG. 1 is a block diagram of one example embodiment of an IRMS augmented reality (AR) object detection and classification arrangement of the present invention for a motor vehicle.

FIG. 2 is a schematic diagram of one example traffic scenario in which the motor vehicle of FIG. 1 may be involved.

FIG. 3 is an example plan view of the IRMS display of FIG. 1 in the traffic scenario of FIG. 2.

FIG. 4 is a flow chart of one embodiment of a rearview display method of the present invention for a motor vehicle.

### DETAILED DESCRIPTION OF THE PREFERRED EMBODIMENTS

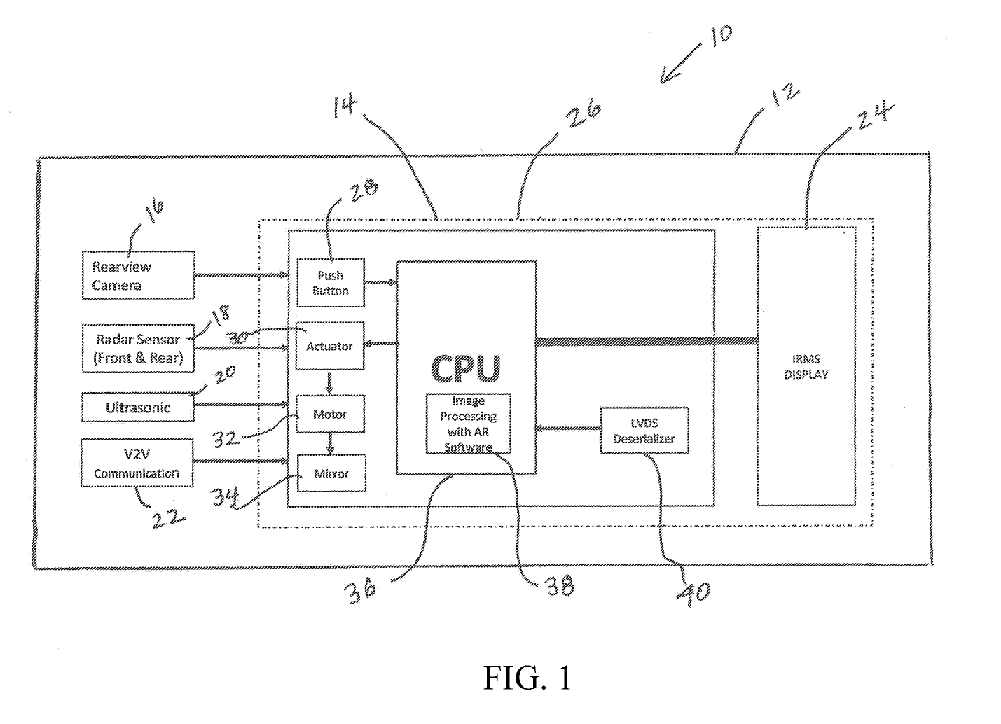

FIG. 1 illustrates one example embodiment of an IRMS augmented reality (AR) object detection and classification arrangement 10 of the present invention installed in a motor vehicle 12. Arrangement 10 includes an IRMS control system 14 and real-time information sources in the form of a rearview camera 16 (or other type of rearview image sensor), front and rear radar sensors 18, an ultrasonic sensor 20, and a vehicle-to-vehicle (V2V) communication device 22.

IRMS control system 14 includes an IRMS display screen 24 and an IRMS display controller 26. IRMS display controller 26 includes a pushbutton 28, an actuator 30, a motor 32, a mirror 34, a central processing unit (CPU) 36 having an image processor 38 with augmented reality software, and a Low-voltage differential signaling (LVDS) deserializer 40.

During use, information sources 16, 18, 20, 22 may send to CPU 36 information signals about objects outside of vehicle 12 in the driver's field of view behind the vehicle, such as in the rearview mirror. Based on these information signals, CPU 36 may detect and classify objects (e.g., bicyclists, pedestrians, other vehicles, motorcyclists, etc.). CPU 36 may cause IRMS display screen 24 to display notifications, overlays, and colors (e.g., red or green dotted lines to the object) to communicate to the driver relevant and/or necessary information via augmented reality in the intelligent rearview mirror display system (IRMS). CPU 36 may enhance the presentation on IRMS display screen 24 to bring the driver's attention to objects in the image being displayed, and to identify to the driver what the objects are.

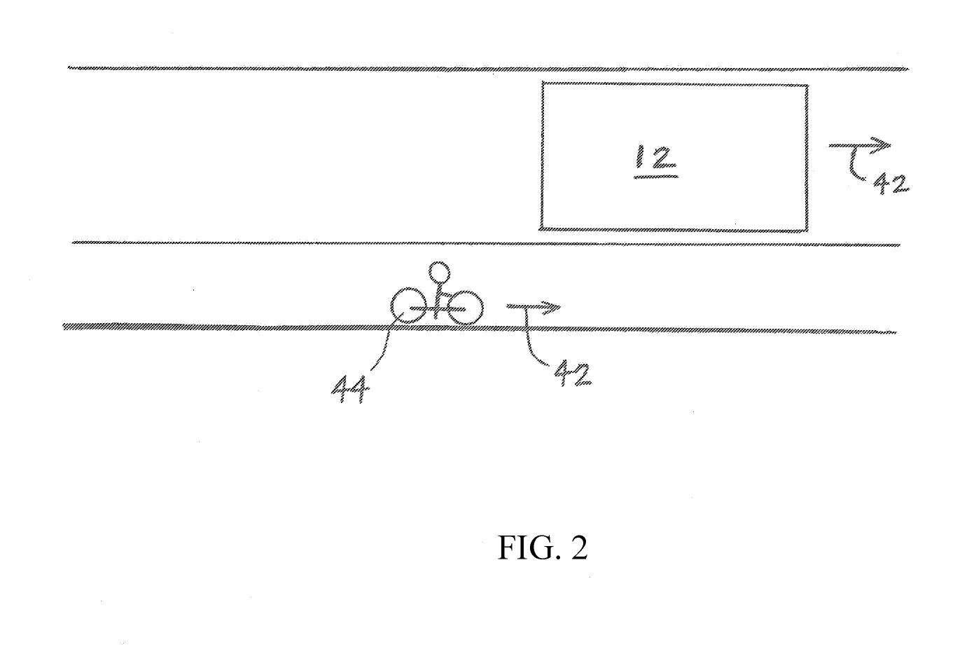

FIG. 2 illustrates one example traffic scenario in which motor vehicle 12 may be involved. Motor vehicle 12 travels in direction 42. A bicycle 44 in a blind spot of vehicle 12 also travels in direction 42.

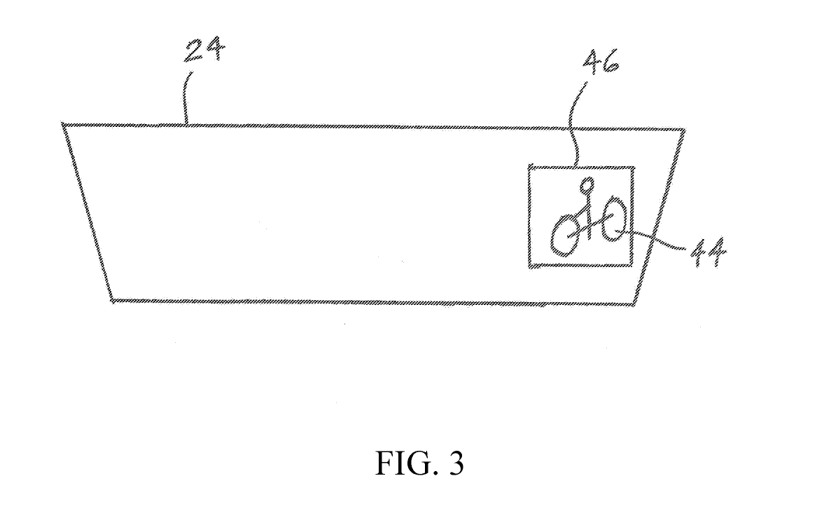

FIG. 3 illustrates IRMS display screen 24 operating in its display mode (i.e., rather than its mirror mode) in the traffic scenario of FIG. 2. The threat in the form of bicycle 44 in the driver's blind spot may be highlighted by a colored box 46 around the threat in order to attract the driver's attention. Colored box 46 may be replaced by a colored closed loop such as an oval or circle. An audible alert tone or voice message may also be played in order to attract the driver's attention.

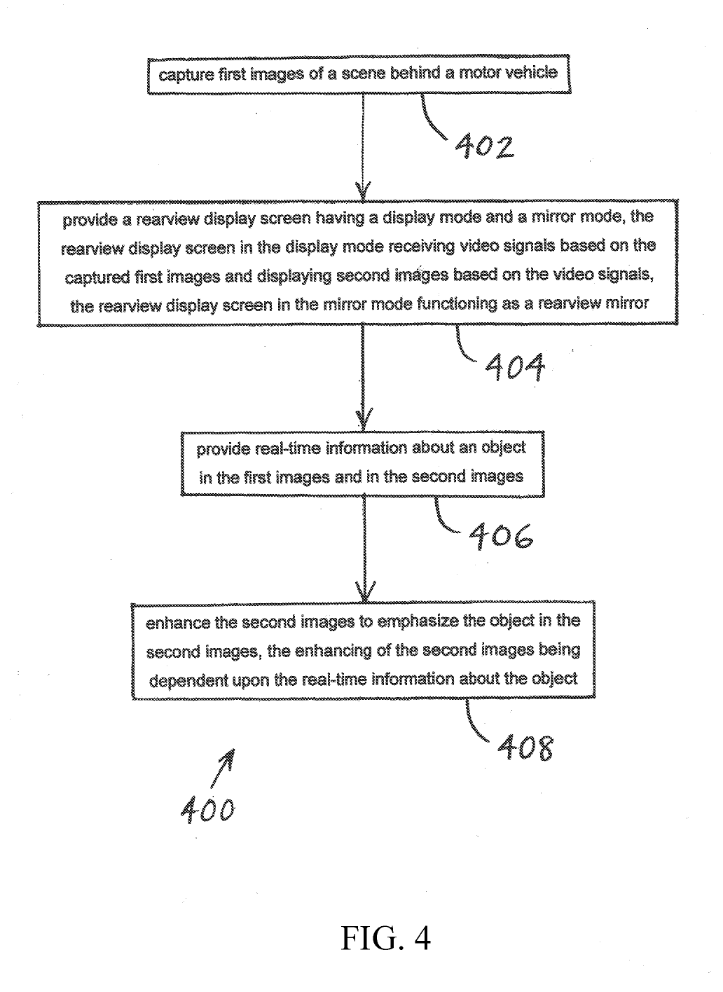

FIG. 4 illustrates one embodiment of a rearview display method 400 of the present invention for a motor vehicle. In a first step 402, first images of a scene behind the motor vehicle are captured. For example, rearview camera 16 may capture images of a scene behind motor vehicle 12.

Next, in step 404, a rearview display screen having a display mode and a mirror mode is provided. In the display mode, the rearview display screen receives video signals based on the captured first images and displaying second images based on the video signals. In the mirror mode, the rearview display screen functions as a rearview mirror. For example, IRMS display 24 may operate in a display mode or in a mirror mode. In the display mode, IRMS display 24 receives video signals from CPU 36 based on the images captured by rearview camera 16 and displays images based on the video signals. In the mirror mode, IRMS display 24 may operate just like a conventional mirror.

In a next step 406, real-time information about an object in the first images and in the second images is provided. For example, arrangement 10 includes real-time information sources in the form of front and rear radar sensors 18, an ultrasonic sensor 20, and a vehicle-to-vehicle (V2V) communication device 22. Information sources 18, 20, 22 may send to CPU 36 information signals about objects outside of vehicle 12 in the driver's field of view behind the vehicle, such as in the rearview mirror, or in the images captured by rearview camera 16.

In a final step 408, the second images are enhanced to emphasize the object in the second images. The enhancing of the second images is dependent upon the real-time information about the object. For example, based on the information signals from information sources 18, 20, 22, CPU 36 may detect and classify objects. CPU 36 may enhance the presentation on IRMS display screen 24 and thereby cause IRMS display screen 24 to display notifications, overlays, and colors to bring the driver's attention to objects in the image being displayed.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A rearview display arrangement for a motor vehicle, the arrangement comprising:
a rearview image sensor positioned to capture first images of a scene behind the motor vehicle;
a rearview display screen having a display mode and a mirror mode, the rearview display screen being configured in the display mode to receive video signals based on the captured first images and display second images based on the video signals, the rearview display screen being configured in the mirror mode to function as a rearview mirror;
an information source configured to provide real-time information about an object in the first images and in the second images; and
an electronic processing apparatus communicatively coupled to the rearview image sensor, to the rearview display screen, and to the information source, the electronic processing apparatus being configured to enhance the second images to emphasize the object in the second images, the enhancing of the second images being dependent upon the real-time information about the object.

2. The arrangement of claim 1 wherein the rearview image sensor comprises a camera.

3. The arrangement of claim 1 wherein the information source comprises front and rear radar sensors.

4. The arrangement of claim 1 wherein the information source comprises an ultrasonic sensor.

5. The arrangement of claim 1 wherein the information source comprises a vehicle-to-vehicle communication device.

6. The arrangement of claim 1 wherein the electronic processing apparatus is configured to identify the object based upon the real-time information about the object.

7. The arrangement of claim 6 wherein the electronic processing apparatus is configured to inform a driver of the motor vehicle about an identity of the object.

8. The arrangement of claim 1 wherein the electronic processing apparatus is configured to enhance the second images by providing a colored box or closed loop around the object in the second images.

9. The arrangement of claim 1 wherein the electronic processing apparatus is configured to provide to a driver of the motor vehicle an audible alert about the object dependent upon the real-time information about the object.

10. A rearview display method for a motor vehicle, the method comprising:
capturing first images of a scene behind the motor vehicle;
providing a rearview display screen having a display mode and a mirror mode, the rearview display screen in the display mode receiving video signals based on the captured first images and displaying second images based on the video signals, the rearview display screen in the mirror mode functioning as a rearview mirror;
providing real-time information about an object in the first images and in the second images; and
enhancing the second images to emphasize the object in the second images, the enhancing of the second images being dependent upon the real-time information about the object.

11. The method of claim 10 wherein the real-time information is provided by front and rear radar sensors.

12. The method of claim 10 wherein the real-time information is provided by an ultrasonic sensor.

13. The method of claim 10 wherein the real-time information is provided by a vehicle-to-vehicle communication device.

14. The method of claim 10 further comprising identifying the object based upon the real-time information about the object.

15. The method of claim 14 further comprising informing a driver of the motor vehicle about an identity of the object.

16. The method of claim 10 wherein the enhancing of the second images includes providing a colored box or a closed loop around the object in the second images.

17. The method of claim 10 further comprising providing to a driver of the motor vehicle an audible alert about the object dependent upon the real-time information about the object.

18. A rearview display arrangement for a motor vehicle, the arrangement comprising:
a rearview camera positioned to capture first images of a scene behind the motor vehicle;
a rearview display screen having a display mode and a mirror mode, the rearview display screen being configured in the display mode to receive video signals based on the captured first images and display second images based on the video signals, the rearview display screen being configured in the mirror mode to function as a rearview mirror;
a sensor configured to provide real-time location information about an object in the first images and in the second images; and
an electronic processing apparatus communicatively coupled to the rearview camera, to the rearview display screen, and to the sensor, the electronic processing apparatus being configured to:
identify the object based upon the real-time location information about the object and the captured first images,
inform a driver of the motor vehicle about an identity of the object; and
enhance the second images to thereby bring the driver's attention to the object in the second images.

19. The arrangement of claim 18 wherein the sensor comprises front and rear radar sensors.

20. The arrangement of claim 18 wherein the sensor comprises an ultrasonic sensor.

21. The arrangement of claim 18 wherein the sensor comprises a vehicle-to-vehicle communication device.

22. The arrangement of claim 18 wherein the electronic processing apparatus is configured to enhance the second images by providing a colored box or closed loop around the object in the second images.

23. The arrangement of claim 18 wherein the electronic processing apparatus is configured to provide to a driver of the motor vehicle an audible alert about the object dependent upon the real-time location information about the object.
